(19) United States
(12) Patent Application Publication
(10) Pub. No.: US 2003/0051037 A1
(43) Pub. Date: Mar. 13, 2003

(54) Open portal interface manager

(76) Inventors: Mukesh Sundaram, San Jose, CA (US); Rajiv Dharmadhikari, Milpitas, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/993,802

(22) Filed: Nov. 5, 2001

Related U.S. Application Data
(60) Provisional application No. 60/297,837, filed on Jun. 12, 2001.

(51) Int. Cl. G06F 15/16

(52) U.S. Cl. 709/227

(57) ABSTRACT

Call control operations are performed at an application server communicatively coupled as a session initiation protocol (SIP) proxy between a media gateway and a media server according to application profiles for one or more automated communication applications to be executed by the media server according to voice extensible markup language (VXML) instructions, the call control operations being performed in response to events that occur during execution of the automated communication applications, said events including failures of the automated communication applications. The events may be one or more of: a timeout or other errors during communication between the media server and a document server, a call transfer process initiated by the media server, a call queuing operation initiated by the media server, a script execution initiated by an enterprise call router communicatively coupled to the application server, or a carrier-based transfer connect process requested by the media server.

### RELATED APPLICATION

This application is related to and hereby claims the priority date of U.S. Provisional Application No. 60/297,837, entitled “Open Portal Interface Manager”, filed Jun. 12, 2001 by the present inventors.

### FIELD OF THE INVENTION

The present invention relates to the field of telecommunications and, in particular, to voice-enabled telecommunication systems that utilize the Voice Extensible Markup Language (VXML) to create and control interactive voice response (IVR) systems.

### BACKGROUND

“Softswitch” is a term being used by the International Softswitch Consortium (ISC) of San Ramon, Calif. to describe so-called “next-generation” communications systems that employ standards-based solutions to create intelligent networks wherein the network “intelligence” is decoupled from the voice, video and data traffic. According to the ISC, this architecture will allow for improved value-added services over those which can be provided using the circuit-switched public switched telephone network (PSTN). The separation of call control and services from the underlying transport network is said to be a key enabling feature of softswitch-based networks.

FIG. 1 illustrates a reference architecture for a softswitch-based network 10. In this network 10, incoming calls from the PSTN are terminated at a media gateway 12. The media gateway 12 acts as an interface between the time division multiplexed (TDM) PSTN and a voice over Internet Protocol (VoIP) network 14. In some cases, a media gateway may include a gatekeeper and, in any event, the media gateway 12 converts the voice and signaling information from the PSTN to IP packets. Alternatively, call signaling may be handled by a separate signaling gateway (not shown). Controlling the operation of the media gateway 12 is a softswitch 16, which communicates with the media gateway 12 over a signaling channel 18. Where a separate signaling gateway is used, the softswitch 16 would be connected to that signaling gateway over a separate signaling channel (not shown). Softswitch 16 is essentially a call controller that is implemented in software and runs on a standard computer platform. The softswitch 16 can direct the switching activities of the media gateway 12 via signaling channel 18 to allow the media gateway 12 to perform the call set up and tear down activities needed to bridge calls between the PSTN and the IP network 14.

Working in conjunction with the softswitch 16 is an application server 20. The application server 20 communicates with the softswitch 16 via a signaling and control channel 22 and passes information concerning the particular application to be run. That is, the application server 20 may pass information concerning available ports for a particular call application to service incoming calls from the PSTN and so on. The call application itself (i.e., the IVR application) is executed on a server (not shown) that is in communication with a media server 24, which itself is in communication with the application server 20 via a control channel 26, and with the media gateway 12 via a data channel 28. In many applications, the data channel 28 may use a Real Time Transport protocol (RTP) channel, while the control channel 26 may use a Session Initiation Protocol (SIP) channel.

RTP provides delivery service for multimedia applications and also provides means for multimedia applications to work over computer networks. RTP does not, however, provide guaranteed or in-sequence delivery (and hence it is referred to as an unreliable transport protocol), but does provide a packet sequence number that can be used to detect missing packets and to reconstruct an original transmission sequence.

RTP usually carries data in the form of packets, using the user datagram protocol (UDP) as the delivery mechanism. UDP provides a “wrapper” around data packets, with the wrapper providing for multiplexing and demultiplexing as well as error checking services. Essentially, a UDP packet is made up of a UDP header and UDP data encapsulated as the data portion of an IP packet. The IP packet itself includes an IP header (which includes the address information) as well as the user data (i.e. the multimedia content of interest) as a payload.

In some cases, RTP is used with other protocols, such as the transmission control protocol (TCP). Unlike UDP, TCP provides a reliable, error-free, full-duplex channel between two computers. TCP uses IP to transfer data, but provides mechanisms to take care of lost or duplicated IP datagrams (i.e., packets) and to ensure proper sequencing thereof. Thus, TCP provides reliable end-to-end transport, ensuring that what is received is an exact duplicate of what is transmitted.

When an application starts an RTP session, a second port for communication according to the real time control protocol (RTCP) is opened. RTCP works in conjunction with RTP to provide flow control and congestion control services. The idea is that the exchange of RTCP packets between a client and server can be used to adjust the rate of transmission of the RTP packets, etc.

The RTP portion of channel 28 contains actual media data for single stream flows (e.g., compressed audio data). In contrast, an RTCP portion of a channel (which typically is assigned one UDP port number or TCP channel number larger than the RTP port number or channel—for example, UDP port 6970 for RTP and 6971 for RTCP) usually contains clock-synchronization data and client-server control/status messages. As indicated above, RTP data typically flows in one direction, from the server to the client. RTCP packets are typically sent in both directions, for example as client status report messages and server status report messages.

SIP is, more or less, equivalent to the Q.931 and H.225 components of H.323. H.323 is part of a family of real-time communication protocols developed under the auspices of the International Telecommunications Union (ITU), the H.32x family. Each protocol in the family addresses a different underlying network architecture e.g., a circuit switched network, B-ISDN, LAN with quality of service (QoS), and LAN without QoS (H.323). All borrow heavily from the original H.320's structure and modularity. H.323 is not an individual protocol, but rather a complete, vertically integrated suite of protocols that defines every component of a conferencing network: terminals, gateways, gatekeepers, MCUs and other feature servers. These protocols are responsible for call setup and call signaling. Consequently, both SIP and H.323 can be used as signaling protocols in IP networks.

In addition to control channel 26, channel 22 may also be a SIP channel. However, it is likely that signaling channel 18 will be a media gateway control protocol (MGCP) channel. MGCP, or its successor Megaco, and SIP are not peers; they can and will coexist in converged networks. MGCP/Megaco does not constitute a complete system: a session initiation protocol is required between gateway controllers.

The media server 24 is often a VXML engine. VXML is an extensible markup language (XML) for the creation of automated speech response (ASR) and IVR applications based on the XML tag/attribute format. The VXML syntax involves enclosing instructions (items) within a tag structure such as:

<element_name attribute_name=”attribute_value”>

. . . contained items . . .

</element_name>

A VXML application consists of one or more text files called documents, often identified by a VXML file extension, that contain the various VXML instructions for the application. Within a document are included a number of discrete dialog elements called forms. Each form has a name and is responsible for executing some portion of the dialog. For example, a form called MainMenu may be responsible for prompting a caller to make a selection from a list of options and then recognizing the response. Among the possible elements that can be included in a form are so-called form items. Form items come in two varieties, field items, which gather information from the caller to fill variables, and control items, which enclose non-recognition based tasks. Examples of field items include prompts that direct a caller what to say, grammars that define the interpretation of what is said, and any event handlers. By stringing together the forms and using various flow control elements (e.g., <goto>, <if>, <else>, <else if>, etc.), one can create an ASR or IVR application to accomplish a given task.

In addition to the VXML instructions, an ASR or IVR application will require a grammar. A grammar is a database that can be used by a speech recognition system to understand the words and phrases that are expected to be received from a caller. Referring now to FIG. 2 can aid in understanding the role of the grammar.

Most users are familiar with a conventional web browser/web server interaction. For example, a user may launch a web browser application (e.g., Microsoft™ Internet Explorer™ or Netscape™ Navigator™) on his or her personal computer (PC) 30. The browser communicates with a web server 32 using hypertext markup language (HTML) instructions 34 that tell the browser what images to render on the display of the PC 30. The HTTP instructions are transported using the hypertext transfer protocol (HTTP). Although in the early days of the Internet, the familiar “web pages” viewed by users were truly static pages of content, today many of these “web pages” are really the HTML output provided by various computer programs or scripts 36 that are running on the web server 32. By using such scripts 36, dynamic content that responds to user inputs or selections can be provided. In addition to the raw HTML, media files (that may originate at the web server 32 or elsewhere) are also provided to the browser at PC 30. These files 38 include the actual content (e.g., images, movies, etc.) viewed by the user.

Much like the process described above, VXML was developed to provide for interaction between a user and a computer system. Unlike the web browser scenario discussed above, however, VXML applications assume that the user is equipped with a device such as a telephone 40, rather than a PC 30. Telephone 40 may be any form of such a device, including a traditional desktop telephone, a wireless telephone or a combination telephone-personal digital assistant. Because not all telephone devices include software capable of interacting directly with a computer system, often times a user wishing to perform such an interaction will be instructed to dial a special telephone number that will terminate at a gateway platform 42. As described above, the gateway is the interface between the PSTN world (over which the user's regular telephone call is placed) and an IP network that includes web server 32. The gateway 42 (which acts like the media server 24 discussed with reference to FIG. 1) includes software known as a voice browser 44 that takes the user's utterances and passes them as VXML instructions 46 (using HTTP) to the scripts 36 that run on server 32. Likewise, the scripts 36 pass VXML instructions 46 to the voice browser 44 to play out synthesized speech prompts and/or replies to the user through the telephone 40.

The prompts/replies themselves are stored as audio files 48 at the server 32 or elsewhere. Also, in order for the voice browser 44 to understand the utterances made by the user on the telephone 40, grammar files 48 are provided. As an example of how such a system might be utilized, consider an automated system for ordering movie tickets. A user may dial up the ticket purchasing service using telephone 40 and be connected to a server 32 through a voice browser 44. Upon making a connection, the server 32 may begin executing a script 36 that first instructs the browser 44 to play a welcome message. This welcome message may be included in one or more audio files 48 that are accessed by the browser 44 in response to the VXML instructions 46 passed by the script 32.

The welcome message may include an instruction asking the user to enter or select the theater for which the user wishes to purchase tickets. In the case of a voice selection, the grammar files 48 provided to the browser 44 will be such as to assist the browser in capturing an expected utterance, for example the number of a selection or the name of a movie theater. This prompt and response form of communication may continue until the user has completed his or her ticket selection. After the call is terminated, the various communication channels between the gateway 42 and the server 32 may be torn down to free up resources for new calls.

### SUMMARY OF THE INVENTION

A communications network includes a media server, a media gateway and a call controller configured to provide reliability handling for events experienced during a call session between the media server (e.g., a VXML engine) and the media gateway (which may be coupled to receive calls from a telephone network). The reliability handling may include the provision of voice extensible markup language (VXML) instructions to the media server to retrieve applications from one or more document servers. These VXML instructions include uniform resource locators (URLs) identifying the location of the applications. In some cases, the call controller includes an interface adapted for communication with an enterprise call router. A VXML document server for storing the VXML application to be executed by the media server may be communicatively coupled to the media server. The exception handling may include rejecting or transferring calls, as appropriate. In general, the exception handling is based on application profiles for automated communication applications to be executed by the media server.

Another embodiment provides a computer-implemented process wherein an event in a call flow process for an automated communication session in which the media server interacts with a caller through a media gateway is recognized; and, in response thereto, an application server communicatively coupled with the media server and the media gateway invokes one or more reliability handlers for coping with the event according to an application profile for the automated call session. The reliability handlers may provide one or more of: uniform resource locators (URLs) at which applications to be executed by the media server are located, call rejection instructions, or call transfer destination telephone numbers. In some cases the above-mentioned URLs correspond to documents stored at the application server. In other cases, the URLs correspond to documents stored at one or more document servers communicatively coupled to the media server. The reliability handlers may respond to the event by transmitting instructions to the media server to retrieve backup documents (i.e., VXML applications) for processing a call from one or more document servers. Events for which these procedures may be invoked include: a timeout during communication between the media server and a document server, a call transfer process initiated by the media server, a call queuing operation initiated by the media server, a script execution initiated by an enterprise call router communicatively coupled to the application server, or a carrier-based transfer connect process requested by the media server.

A further embodiment involves performing call control operations at an application server communicatively coupled as a session information protocol (SIP) proxy between a media gateway and a media server according to application profiles for one or more automated communication applications to be executed by the media server according to voice extensible markup language (VXML) instructions, the call control operations being performed in response to events that occur during execution of the automated communication applications, said events including failures of the automated communication applications. As indicated above, the events may be one or more of: a timeout during communication between the media server and a document server, a call transfer process initiated by the media server, a call queuing operation initiated by the media server, a script execution initiated by an enterprise call router communicatively coupled to the application server, or a carrier-based transfer connect process requested by the media server. The application profiles are retrieved from a directory accessible by the application server at a time when a call session is established.

### BRIEF DESCRIPTION OF THE DRAWINGS

The present invention is illustrated by way of example, and not limitation, in the figures of the accompanying drawings in which:

FIG. 1 illustrates an example of a reference architecture for a softswitch network;

FIG. 2 illustrates similarities between a conventional HTML session between an Internet browser and a server and a VXML session between a voice browser and a server;

FIG. 3 illustrates one embodiment of an open portal interface manager (OPM) configured for use with a media gateway and a media server in accordance with the present invention;

FIG. 4 is a call flow diagram illustrating interaction between the media gateway, the OPM, the media server and a document server for an IVR call application in accordance with one embodiment of the present invention;

FIG. 5 is a call flow diagram illustrating interaction between the media gateway, the OPM, the media server and a document server during a call rejection process for an IVR call application in accordance with one embodiment of the present invention;

FIG. 6 is a call flow diagram illustrating interaction between the media gateway, the OPM, the media server and a document server during a timeout event for an IVR call application in accordance with one embodiment of the present invention;

FIG. 7 is a call flow diagram illustrating interaction between the media gateway, the OPM, the media server and a document server during a call transfer event of a first type for an IVR call application in accordance with one embodiment of the present invention;

FIG. 8 is a call flow diagram illustrating interaction between the media gateway, the OPM, the media server and a document server during a call transfer event of a second type for an IVR call application in accordance with one embodiment of the present invention;

FIG. 9 is a call flow diagram illustrating interaction between the media gateway, the OPM, the media server and a document server during a successful call transfer event without call bridging for an IVR call application in accordance with one embodiment of the present invention;

FIG. 10 is a call flow diagram illustrating interaction between the media gateway, the OPM, the media server and a document server during a failed call transfer event without call bridging for an IVR call application in accordance with one embodiment of the present invention;

FIG. 11 is a call flow diagram illustrating interaction between the media gateway, the OPM, the media server and a document server during a successful call transfer event with call bridging for an IVR call application in accordance with one embodiment of the present invention;

FIG. 12 is a call flow diagram illustrating interaction between the media gateway, the OPM, the media server and a document server during a failed call transfer event with call bridging for an IVR call application in accordance with one embodiment of the present invention;

FIG. 13 is a call flow diagram illustrating interaction between the media gateway, the OPM, the media server and a document server during a call queuing and transfer event for an IVR call application in accordance with one embodiment of the present invention;

FIG. 14 is a call flow diagram illustrating interaction between the media gateway, the OPM, the media server and a document server during a process wherein an IVR call application is executed according to instructions from an enterprise call controller in accordance with one embodiment of the present invention; and

FIG. 15 is a call flow diagram illustrating interaction between the media gateway, the OPM, the media server and a document server during a carrier-based transfer connect process for an IVR call application in accordance with one embodiment of the present invention.

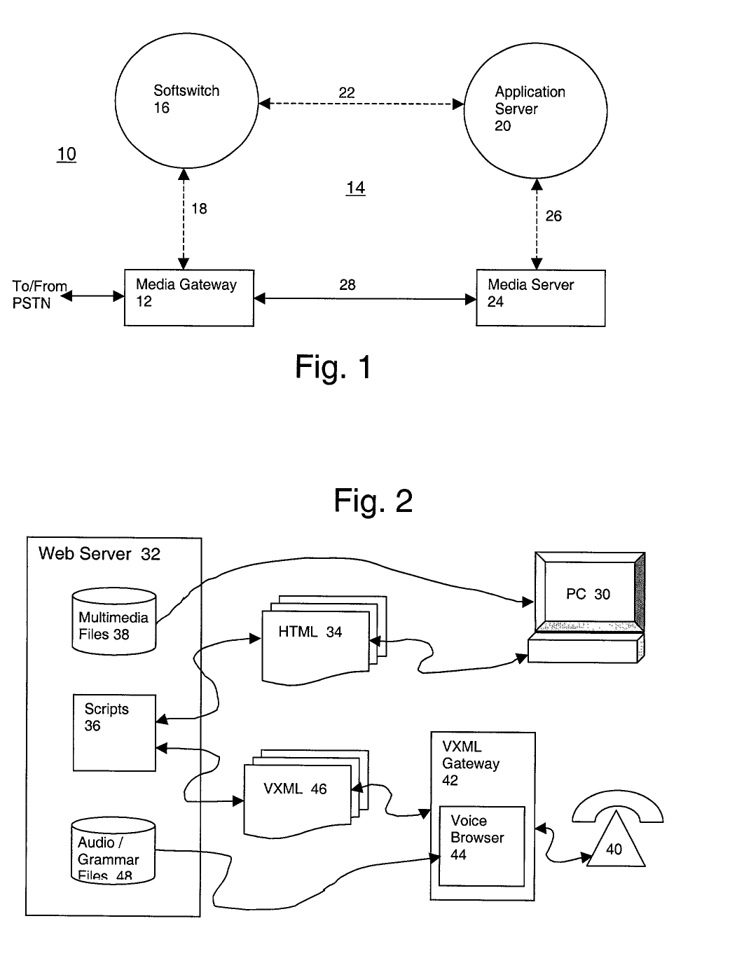

### DETAILED DESCRIPTION

Described herein is an open portal interface manager (OPM), which in one embodiment may be implemented as computer software that provides open-protocols based application programming interfaces (APIs) to media gateways and media servers incorporating VXML engines. These APIs may, in one embodiment, be based on the well known SIP and HTTP protocols. In such an embodiment, the OPM resembles an application server in the softswitch reference architecture and is responsible for managing communications between a media gateway and a media server according to a defined rule set. The OPM also facilitates reporting of events that involve the media gateway and media server.

The examples of the OPM systems discussed herein should be understood as being just that, examples only, and should not be read as restricting the broader scope of the present invention. The reason for using and discussing the examples herein is to provide the reader with an easy to understand application in which the present invention may find use. Readers will understand that it would be overly tedious and unnecessary to explain in detail or even list each and every possible application and/or configuration of the present invention, in part because such a list would not significantly contribute to the communication of the central ideas which make up the present invention and, besides, these broad concepts are described and encompassed in the claims which follow this description.

Some portions of this detailed description are presented in terms of algorithms and/or symbolic representations of operations on data within a computer memory. These algorithmic descriptions and representations are the means used by those skilled in the computer science arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers or the like. It should be borne in mind, however, that all of these and similar terms are to be associated with the appropriate physical quantities and are merely convenient labels applied to these quantities. Unless specifically stated otherwise, it will be appreciated that throughout the description of the present invention, use of terms such as “processing”, “computing”, “calculating”, “determining”, “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

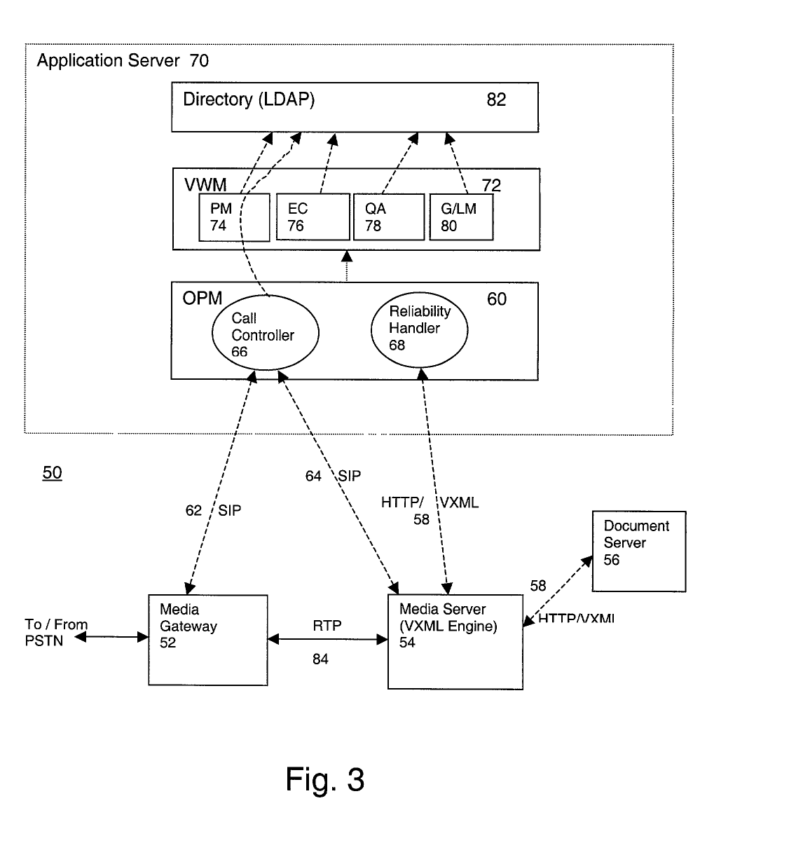

With the above in mind, refer now to FIG. 3, which illustrates an example of the present OPM and its place in a network. Network 50 includes a media gateway 52, which acts as an interface between network 50 and the PSTN, as discussed above. Also included in network 50 is a media server 54, which includes a VXML engine configured to respond to VXML instructions received from a document server 56. The document server 56 acts as a repository for various VXML documents that can be downloaded to the media server 54 as required. Documents for various ASR and/or IVR applications may be so provided depending upon the context and needs of an incoming call received at media gateway 52. The documents are downloaded over an HTTP channel 58 in the conventional fashion and according to instructions provided by the OPM 60, as discussed in detail below.

OPM 60 is a software component (which includes a number of subcomponents) that is configured for execution on a computer hardware platform. Thus, OPM 60 may exist as a series of computer-readable instructions stored on a computer-readable medium such as a hard disk for execution by a computer processor. In other cases, OPM 60 may be implemented as firmware for programming reconfigurable logic and/or as one or more application specific integrated circuits or a combination of the above. The precise nature of OPM 60 is not critical to the present invention and in the remaining discussion it will be the functionality of OPM 60 that is of primary importance.

Like other application servers, OPM 60 has control channels 62 and 64 for communication with the media gateway 52 and media server 54, respectively. Messages passed on these control channels 62, 64 are compatible with SIP. As discussed further below, many conventional SIP messages are passed between these components and, in addition, some non-conventional messages may also be passed depending upon the context of a call.

Subcomponents of the OPM 60 may include a call controller 66 and a reliability handler 68. Call controller 66 is a SIP proxy that minimally monitors call control transactions, but can also act as a call manager in conjunction with a resource manager. The reliability handler 68 is a set of VXML control applets that work in conjunction with the call controller to control the behavior of the VXML engine of the media server 54 based on application profile settings. The application profile settings are established at the time the OPM 60 is deployed within a network and are customer-specific. That is, for each customer application one or more document servers 56 may provide instructions to the VXML engine. A profile of that application is established so that the appropriate supervisory control may be provided for calls interacting with that application. Based on these profiles, call redirections, load balancing operations and recovery procedures may be implemented as needed (e.g., in the event of errors that occur during delivery of a VXML application), without the need for human operator intervention. The precise coding of these call control and other applets is not critical to the present invention, rather it is the set of functions which they provide which are important and which are described further in connection with the call flow diagrams discussed below.

In some cases, the OPM 60 may also include a resource manager. This is not critical to the present invention as sometimes the resource manager is included with the media server(s) 54 or a softswitch. In either case, the resource manager is a software component that acts as a VXML port manager. As such, the resource manager understands the characteristics of a set of VXML ports (i.e., the available ports of the media server(s)) and manages this pool of resources for the call controller 66. The resource manager also understands the characteristics of media gateway ports and manages the pool of media gateway resources for the call controller 66. Based on the application provisioning parameters (i.e., the profile settings), the call controller uses the resource manager to identify an appropriate VXML engine endpoint for a given inbound call received at the media gateway 52.

In one embodiment, the application profile settings are established within a higher software layer of the application server 70, called the voice web manager (VWM) 72. The VWM 72 includes a policy manager 74, which is responsible for implementing the profile settings. That is, the policy manager 74 enforces the policies that are configured for an ASR or IVR (or other) application. For example, one of the profile settings may indicate the type and/or number of required ports for handling a particular call. Upon receipt of a call, the policy manager 74 will be consulted to determine whether or not the call can be accepted. This decision will be based on the requirements specified by the profile settings, the available resource information reported by the resource manager and the number of active calls across the network. The results of the decision will be passed down to the OPM 60 and the OPM 60 will either begin to set up the call path between the media gateway 52 and media server 54 or will instruct the media gateway 52 to reject the call, as appropriate. With the exception of this policy manager 74 (which could be implemented as part of the OPM 60), the remaining components of the VWM 72 are optional.

In addition to a policy manager 74, the VWM 72 may include an event collector 76. As the name implies, the event collector 76 gathers information regarding each event in a call flow. Such events include call appearance, call answer, call transfer, call hang-up, etc. This information may be used to perform statistical analysis of call patterns, to provide for report generation (e.g., call detail reports) and/or to troubleshoot failures. The information collected by the event collector may also be used to generate bills and other reports, as appropriate. A detailed discussion of the event collection is not required for further understanding of the present invention.

Other components of the VWM 72 may include a queue adapter 78. The queue adapter 78 acts as an interface between the VWM 72 (and hence the OPM 60) and an external call controller, such as an intelligent call router that may be deployed at a customer site as part of a local area network (e.g., at the enterprise level). As will be explained in further detail below with the aid of a call flow diagram, the provision of a queue adaptor 78 allows for situations where a customer (i.e., an organization providing IVR or ASP or other voice interactive applications) wishes to utilize an existing enterprise call router in conjunction with the other aspects of the OPM 60. Thus, an external enterprise call router may be used to direct calls to available media servers 54 and/or to perform other call control operations.

Finally, the VWM 72 may include a grammar and log manager module 80. As indicated above, the grammar may be needed to provide the media server(s) 54 with a collection of expected utterance files for use during voice capture operations. Likewise, the log manager module is used in conjunction with synthetic speech applications that may play out audio for a caller. Such modules 80 may be stored as part of the VWM 72 or as separate files at or accessible by the media server 54.

Another component of application server 70 may be one or more directories 82, which is accessible through the lightweight directory access protocol (LDAP). LDAP is a set of protocols for accessing information about directories stored on computer systems (e.g., servers). Using LDAP frees an application from having to know about specific protocols for use in accessing various types of databases. Thus, information stored in different databases may be accessed through a common set of protocols, provided the directories present LDAP-compatible interrogation interfaces.

In the present context, the types of databases that may be written to or read by VWM 72 and/or OPM 60 include databases that collect and organize call event information (e.g., for billing and/or troubleshooting, etc.), various profile settings for customer applications, and so on. These databases need not necessarily be stored at application server 70 and, may instead, be stored elsewhere, accessible through one or more computer network(s) according to conventional LDAP-formatted messages.

Having thus described the various components depicted in FIG. 3, some discussion of their operation is appropriate. In a typical call scenario, a call will arrive from the PSTN at the media gateway 52. As indicated previously, the media gateway 52 is responsible for terminating the PSTN call and interfacing it to the remaining portions of network 50. However, before that can be done, a check must be made to determine whether there are any available resources to accept the call. Thus, the media gateway 52 will transmit an INVITE request, using SIP, to the call controller 66 of the OPM 60. The INVITE message is a conventional SIP message and is a request sent to a service (in this case the corresponding VXML application) requesting participation in a session. A successful SIP invitation consists of two transactions: an INVITE request followed by an ACKnowledgement from the requested service. Further details of these and other conventional SIP messages may be found in M. Handley et al., “SIP: Session Initiation Protocol”, RFC 2543, Internet Engineering Society Group, Network Working Group (Mar. 1999), incorporated herein by reference.

The call controller acts as a SIP proxy (i.e., the proxy for the service being requested in the INVITE message) and contacts the policy manager 74 of the VWM 72 to decide whether or not to accept the call. The policy manager 74 makes this decision based on information regarding the type of resources needed to satisfy the call and the types of resources available at the present time. Based on the called number, the policy manager 74 consults an appropriate database 84 to obtain the profile for the application associated with the called number. The profile may include a pre-configured (provisioned) list of items or set of data that inform an application (in this case the OPM 60) how to handle a call. Among other things, the profile may include the URLs of the VXML application to contact (e.g., a set of primary and backup URLs at which this application may be found); services required to execute the application (e.g., text-to-speech resources, speech recognition resources, etc.); trunking information; port requirements; and so on. The URLs of the VXML application are associated with one or more document servers 56 that store the actual applications.

Assuming the call can be accepted, the policy manager 74 so informs the call controller 66 and the call controller 66 then searches for an appropriate VX endpoint with the help of the resource manager (which may be part of the OPM 60 or may be a separate resource manager associated with the media server(s) 54). The resource manager is responsible for identifying whether one or more media servers 54 that fulfill the requirements of the application profile is/are available for the new call. Once an appropriate endpoint (i.e., media server 54) is found, the call controller 66 passes on an INVITE message across channel 64.

In response to the INVITE message from the call controller 66, the media server 54 (which includes a VXML engine) returns an OK message (note, throughout the description, OK messages should be understood as being 200 OK messages in accordance with the SIP protocol, as described in RFC 2543). The call controller 66 relays this OK message to the media gateway 52 and information included in the OK message allows the media gateway to establish an RTP session with the media server across channel 84. This channel will thus carry the call information within network 50 and media gateway 52 will serve as the interface between the RTP session and the PSTN from which the call originated. Note that although the media server 54 is logically separate from the media gateway 52, there may be instances when both components are instantiated on the same computer hardware.

The above is a brief introduction to the operation of the OPM 60. As will be discussed in further detail below with the help of call flow diagrams, the OPM 60 provides for network-wide policy management to enforce port sharing arrangements specified by application profiles. In addition, the OPM can provide a backup uniform resource locator (URL) to alternative document servers if a primary document server 56 is not responding. Calls can also be transferred to pre-provisioned telephone numbers in response to document server failures or other events. Integration with enterprise call routers is provided for through the queue adapter 78 and this also provides a mechanism for passing caller entered digits (CED). Carrier-based transfer connect features can also be handled without any change in a VXML application and the OPM 60 hides the details of such processes from the VXML application developer.

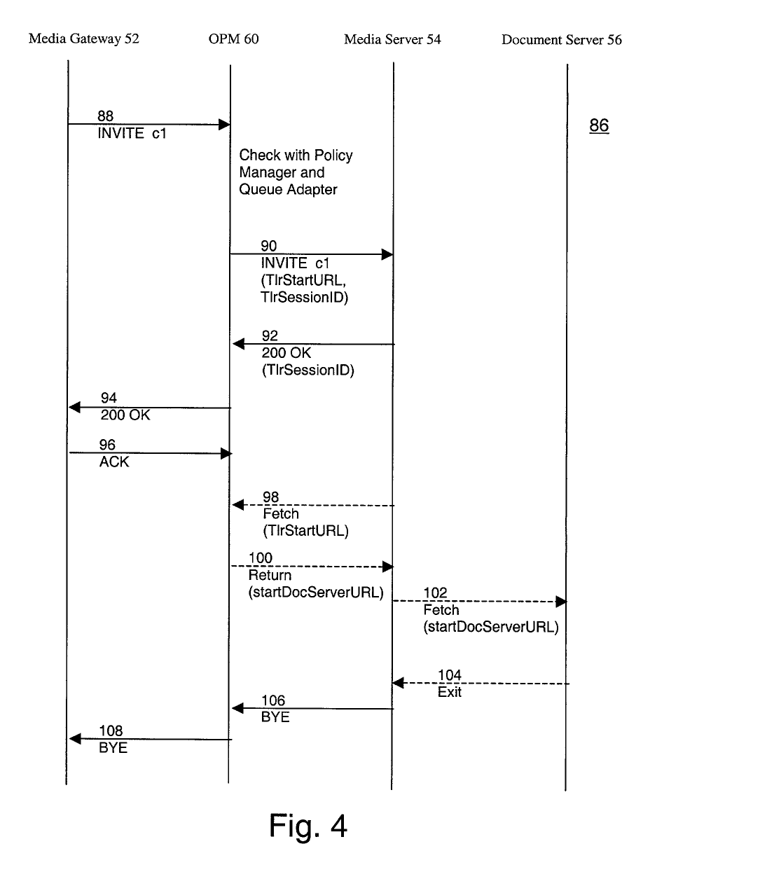

FIG. 4 is the first of a number of call flow diagrams which will be used to further explain the operation and features of the OPM 60. Each of these call flow diagrams (FIGS. 4-15) show traces for the media gateway 52, the OPM 60, the media server (VXML engine) 54 and the actual VXML document server 56. The traces are read top to bottom, and only the signaling or control information streams are shown. Actual call data streams between the PSTN, the media gateway 52 and the media server 54 are not shown so as not to unnecessarily complicate the following discussion. Furthermore, not all SIP messages that may be passed between the network components are shown in detail because such messages are conventional in nature and conform to the requirements of RFC 2543. Nevertheless, it should be understood that such message passing may be required for proper operation of network 50 and such conventional message passing is assumed to occur for purposes of the present invention.

In the call flow diagrams, solid message lines between the network components represent messages passed according to SIP. Dashed message lines represent messages passed according to HTTP. As indicated only signaling messages are shown for sake of clarity.

FIG. 4 illustrates a call flow process 86 for an IVR application and is meant to be an example of a call flow that proceeds without any exceptions or errors. Call flow process 86 begins when the media gateway 52 receives a call from the PSTN (not shown) and sends an INVITE message 88 to OPM 60. As indicated above, in response to the INVITE message, the OPM 60 checks with the policy manager module 74 of the VWM 72 to determine if the call can be accepted. In this example, the call can be accepted and the INVITE message 90 is passed on to the media server 54.

In addition to the information contained in the conventional INVITE message, the OPM 60 passes two other pieces of information to the media server 54; one is a start URL (TlrStartURL) and the other is a session identifier (TlrSessionID). These pieces of information are passed in two new fields of the INVITE message using the SIP. The start URL field identifies the initial web address (URL) for the VXML engine of the media server 54 to obtain execution content. The session ID field specifies a unique identification number for each call and is used in all SIP messages to/from the media server 54 to aid in proper interpretation of those messages.

In response to the INVITE message, the media server 54 returns an acknowledgement in the form of an OK message 92, identified with the session ID number. The OPM 60 passes this along to the media gateway (message 94), which responds with an ACK message 96. This allows the bearer channel 84 to be set up between the media server 54 and the media gateway 52 as each is now aware of the other's presence and the session ID can be used to track packets on this channel that relate to the new call.

In addition to passing the OK message 92, the media server 54 passes a Fetch instruction (using HTTP) 98 to the OPM 60, using the URL identified in the TlrStartURL message 90. This URL identifies a page at the OPM 60 which includes the URL of the document server from which the media server should being downloading instructions for the relevant application. In addition to passing down this URL in a Return message 100, the OPM 60 sets up exception handlers that correspond to the target application and according to the application profile that was retrieved from the database 82. The exception handlers, if needed, will be executed by the media server 54 when any of the identified conditions are encountered in the call flow during execution of the VXML application.

In response to the Return message 100, the media server 54 extracts the URL of the call application and begins to Fetch VXML instructions from the designated document server (message 102). This process continues with the media server fetching VXML instructions and responding accordingly, until the time comes for the application to quit (e.g., in response to user input or other event). At that time, an Exit message 104 is passed up from the document server 56 and corresponding BYE messages 106 and 108 are passed through to the OPM 60 and media gateway 52, respectively. The BYE messages are conventional SIP messages and allow the various components of network 50 to release resources for use by new calls.

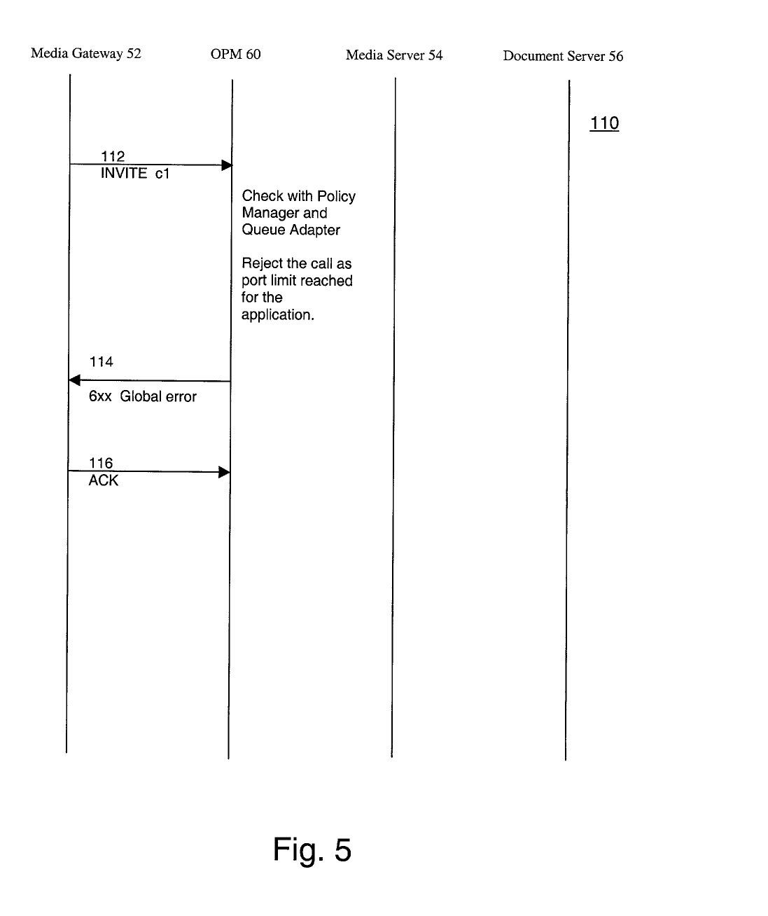

Turning now to FIG. 5, a call reject process 110 is illustrated. As before, the process begins with a new call appearing at the media gateway 52 and the media gateway transmitting an INVITE message 112 to the OPM 60 in response thereto. This time, however, when the OPM 60 checks with the policy manager 74 to see whether or not the new call can be accepted, a determination is made that the call cannot be accepted because the application required to service the call has reached its port limit. Thus, rather than sending on the INVITE message as was the case in the example above, the OPM 60 transmits an error message 114 (e.g., a SIP Global Error message) to the media gateway 52, informing the media gateway that the new call has been rejected. The media gateway 52 transmits an ACK message 116 in response to the error message 114 to confirm that the rejection has been received and the media gateway would then drop the new call.

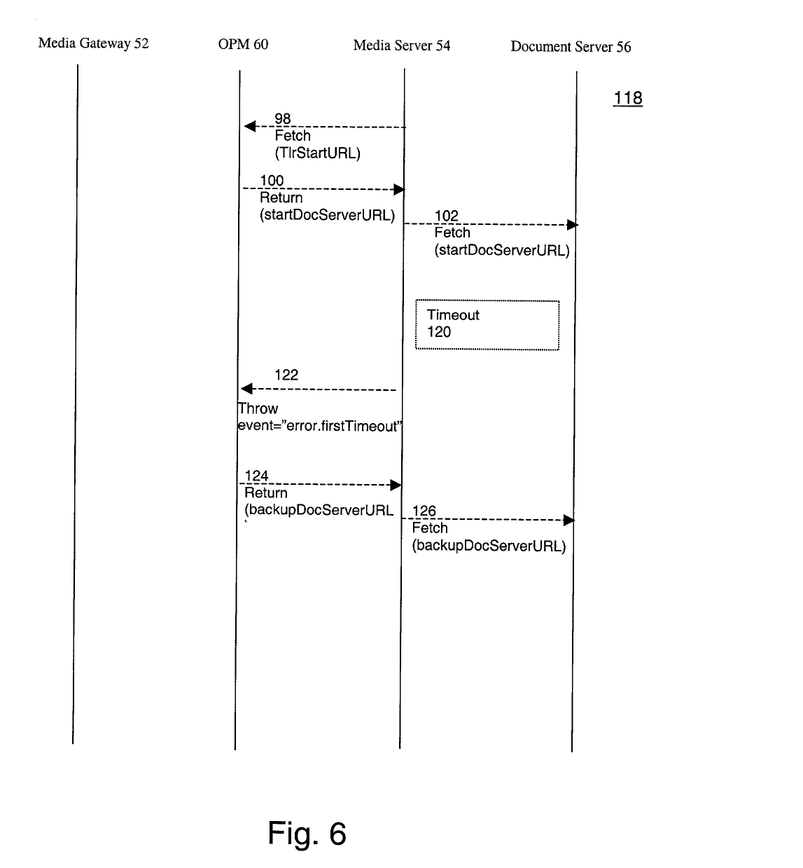

FIG. 6 illustrates a call process 118 that includes an example of how the reliability handler 68 can prevent calls from being dropped even in the presence of an error. For this explanation, assume that the initial call processing was handled as described above with reference to FIG. 4 and, as shown, the media server 54 has been provided with the URL of the customer document server from which to fetch VXML documents (messages 98 and 100) and has made a fetch request to that URL (message 102). This time, however, instead of being provided with VXML documents from document server 56, the request experiences a timeout 120. That is, a prolonged period of time (as determined by a preconfigured threshold) expires before any document is returned from the document server 56. There could be many reasons for such a timeout, for example, the failure may indicate problems with the document server 56 itself, with the network communication link(s) connecting the document server 56 to the media server 54 or some other fault condition. Note, in addition to timeout errors, other types of errors may be handled in a similar fashion. For example, such errors may include XML timeout errors, XML page errors, resource errors (e.g., where an expected page is not found), other server or communication link errors, and any other form of unexpected response. Thus, for this and other discussions below regarding timeout errors, it should be understood that the timeout error is merely being used as an example and this much broader category of errors is also included.

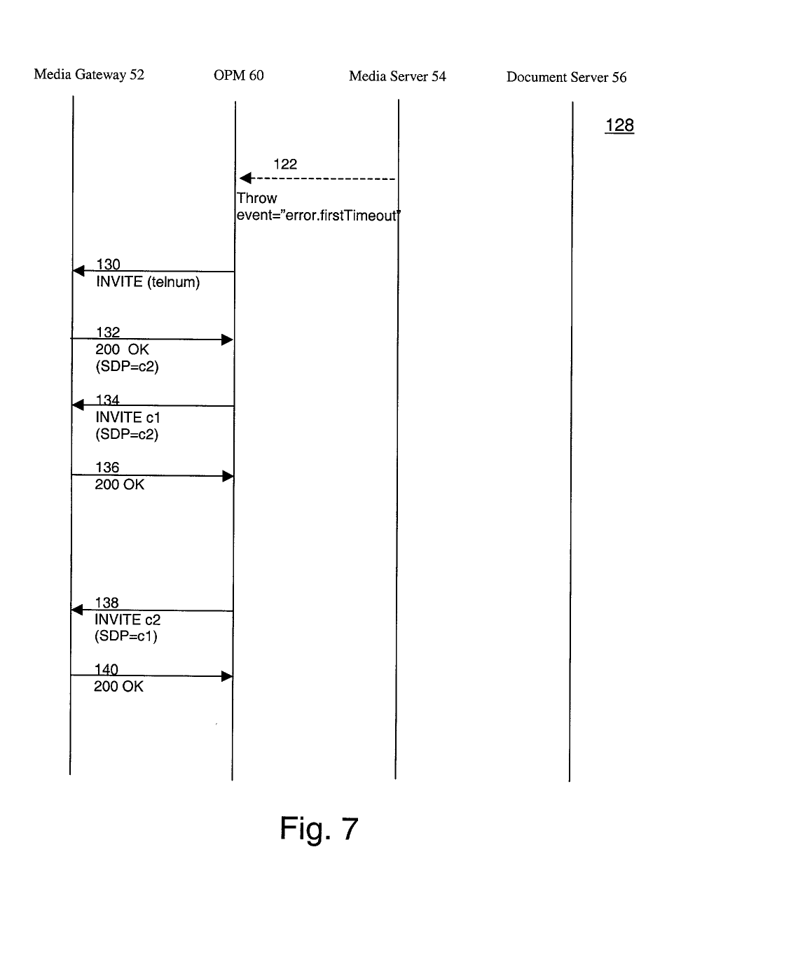

The present invention provides a recovery procedure for such events. As shown in the illustration, when a timeout failure 120 occurs, the media server 52 throws a VXML event whose handler was loaded at the start of the call. This handler directs the media server's VXML execution engine to contact the OPM 60 to report the failure (message 122). In this example, the event is defined as a “first timeout error”. In response, the OPM 60 returns a message 124, which is a VXML document that causes the media server 54 to access a backup URL at which the application VXML document can be found. This backup URL is provided by the reliability handler 68, based on information that was obtained from the application profile at the time the call was initially processed. With the backup URL, the media server may now make a fetch (message 126) to that address and, assuming a connection is made with the document server at the backup URL, begin downloading VXML documents associated with the application. This process may repeat for as many backup URLs as are provided in the application profile until a document server is reached. The case where no successful contact with any document server is made is dealt with below, with reference to FIG. 7.

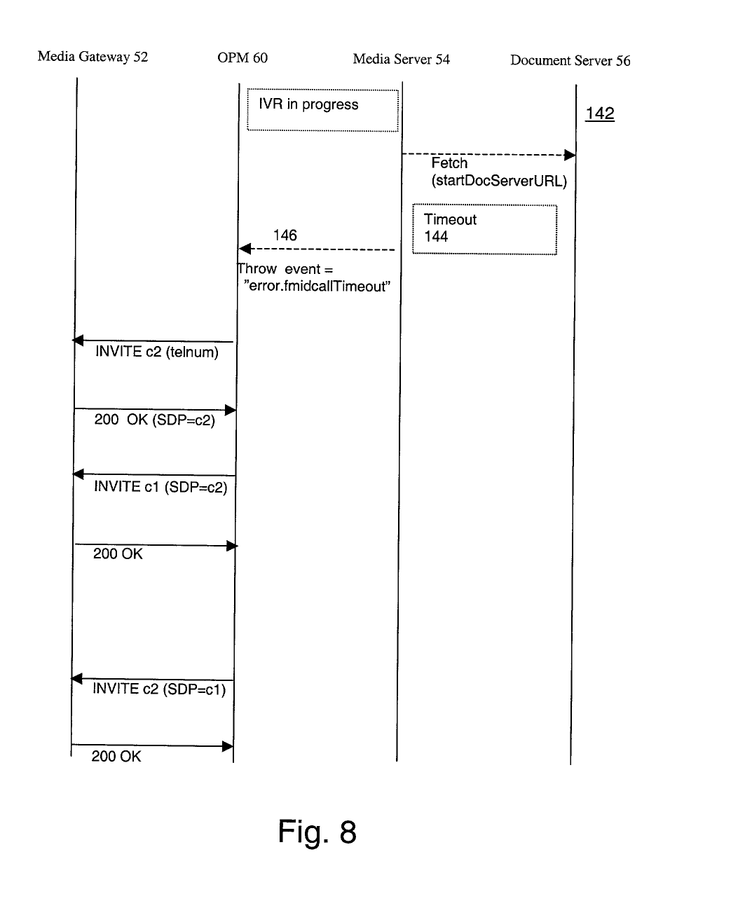

Note that this call process 118 is invoked at the outset of a call, when the first contact with the document server 56 is attempted. In some cases, the call flow may be used if the document server 56 cannot be reached at other times during a call (e.g., at some point during the IVR or ASR application). It is usually inappropriate to restart an application from the beginning (as would happen if, during a call, a backup URL that identified the beginning of a VXML application was provided). For example, this may upset callers that had already entered information in response to prompts. Thus, in many cases, if a call flow fails at some point after an IVR application has been executing, a preferable approach may be to turn the call over to a live operator. In other cases, a recorded message advising the caller of the call flow failure may be played and the caller invited to call back prior to dropping the call. In still other cases, call progress may be monitored so that the reliability handler may keep track of which backup URLs should be used (if more than just the start URL is available for the backup server) during a call. This way, if a timeout occurs, a call may be directed to a backup URL that will provide a more recent (from the caller's point of view) starting point. Of course, this may not be possible if call state depends on caller entered data, and if that data is not available due to a communication failure. Other methods of dealing with timeout errors during a call are discussed below with reference to FIG. 8.

The example of using a backup URL to fetch VXML documents is just one example of the more general exception handling provided by the present invention. Thus, in general, if during a call the media server recognizes an exception or error condition, then depending on the type of exception or error that media server 54 can throw an appropriate exception event whose handler invokes the OPM's handler 68. In response, exception handling routines at the reliability handler 68 can respond as appropriate, and often according to rules for exception handling that were stored in the application profile at the time the application was provisioned. For example, in addition to URLs of document servers as discussed above, other exception handling routines may involve returning URLs of the OPM 60, from which pages can be downloaded by the media server 52. These pages may include HTML and/or VXML instructions for how to handle the call and may include such remedies as passing off the call to another media server, playing out an error message and asking the caller to call back, connecting the caller to a live operator (see, for example, the discussion below with reference to FIGS. 7 and 8), or simply dropping the call. The point is that the ability to recognize an error event and to take steps to deal with the error is provided.

Turning now to FIG. 7, another example of a call flow process 128 to deal with a timeout error is shown. In this example, the timeout occurred as described above, when the media server 54 attempted to contact the document server 56. This may have been the first timeout for the primary URL or a timeout associated with a secondary or other URL. In any event, as discussed above the media server 54 throws an event and contacts the OPM 60 indicating the timeout error (message 122).

At this point, no further backup URLs are available in the application profile, and so the reliability handler 68 recognizes that a different sort of action is required. As part of the application profile, a “provisioned number” was established. This is a telephone number to call in the event of an error such as the present one, where no further backup URLs are available. Rather than simply dropping the call, the application service provider has determined that in such instances the caller should be transferred to a live operator (or at least another telephone number, which could be associated with an IVR application). The reliability handler 68 is responsible for now making sure that the call is passed off to the provisioned number.

To do so, when the OPM 60 receives the error event notification from the media server 52 (message 122), an INVITE message 130 with the provisioned number is provided to the media gateway 52. This is an instruction to the media gateway 52 to place a call to the provisioned number. When the call has been successfully placed, a SIP 200 OK message is returned (message 132 ). At this point, the OPM 60 INVITEs the media gateway to bridge the original call with the new call placed to the provisioned number. Bridging involves two steps, first the original call must be INVITEd to join the new call (messages 134 and 136); and second, the new call must be INVITEd to join the original call (messages 138 and 140). The final OK message 140 indicates successful bridging of the calls. Note, in the illustration, SIP ACK messages have not been shown so as not to unnecessarily obscure the call flow. Note that other methods of transferring a call may be used, and this example should not be seen as limiting the scope of the present invention.

FIG. 8 illustrates an example of placing a call to a provisioned number at a slightly different point during an IVR call flow 142. In this case, the IVR routine is in process when a timeout 144 is reported via an event throw (message 146) from the media server 54 to the OPM 60. Notice that the event type is reported as a “midcall timeout” rather than a start URL timeout as was the case with call flow 128 shown in the previous figure. This is an indication that different provisioned numbers may be specified in an application profile for use according to different exception events. For example, in the case of a starting URL timeout, the provisioned number may just be the telephone number of an associated IVR application which is serviced from a different geographic region. However, in the case of a midcall timeout, the application provider may wish to ensure that the caller is transferred directly to a live operator and not to another IVR process and, hence, the ability to specify a different provisioned number for such occasions is provided. The actual call bridging process may proceed in the fashion described above, and need not be repeated here.

Often times within an IVR application a caller is given the option to exit to a live operator. From a call flow point of view, this usually involves connecting the existing call to another number through which the live operator can be reached. At other times, a call may need to be transferred to another number in response to caller input (e.g., to connect with another automated process. In either of these cases (or in other similar cases) the transfer of the existing call to another telephone number is not just being made in response to an error condition. Rather, it is an expected and proper part of the call flow process. Hence, the reliability handler 68 is not the agent/proxy making the call transition. Rather, the call transfer will be handled by the media server 54, in response to instructions received from the document server 56 as part of the IVR application. Several examples of call flows in such situations will now be discussed.

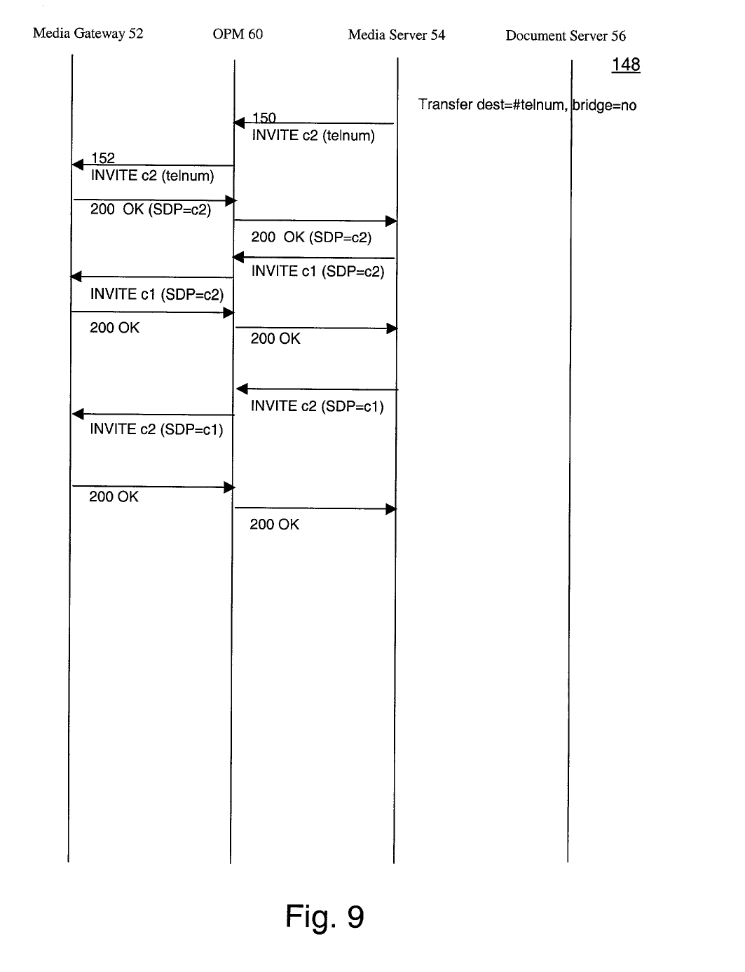

In the first example, illustrated in FIG. 9, a successful call transfer flow 148 is shown. In this example, during the IVR process, the media server 54 receives from document server 56 an instruction to transfer the call to an identified destination telephone number (e.g., associated with a live operator to complete the call). Such a transfer may involve automatic bridging or not. In this case, assume the bridging flag for the operation is set to “no”, indicating that automatic bridging is not to be used (this will have implications for error handling as will be seen below).

The call transfer process resembles the bridging procedures described above for the error handling situations, but as can be seen in the diagram, because the transfer operations take place at the direction of the media server 54 and not the reliability handler 68, all call status messages must be passed through the OPM 60 back to and from the media server 54. Hence, the first INVITE message 150, which includes the transfer destination telephone number that was received from the document server, is transmitted from the media server 54 to the OPM 60, which acts as a SIP proxy and passes the INVITE to the media gateway 52 (message 152). From this point, the bridging process repeats as described above, with the exception that all messages are passed between the media server 54 and the media gateway 52, with the OPM acting as a SIP proxy between the two. When the call is finally connected to the newly placed call, the media server 52 may throw a disconnect event to the OPM 60 to release the call and the associated resources. During the call transfer, the OPM 60 generates call state events to the EC 76 in the VWM 72.

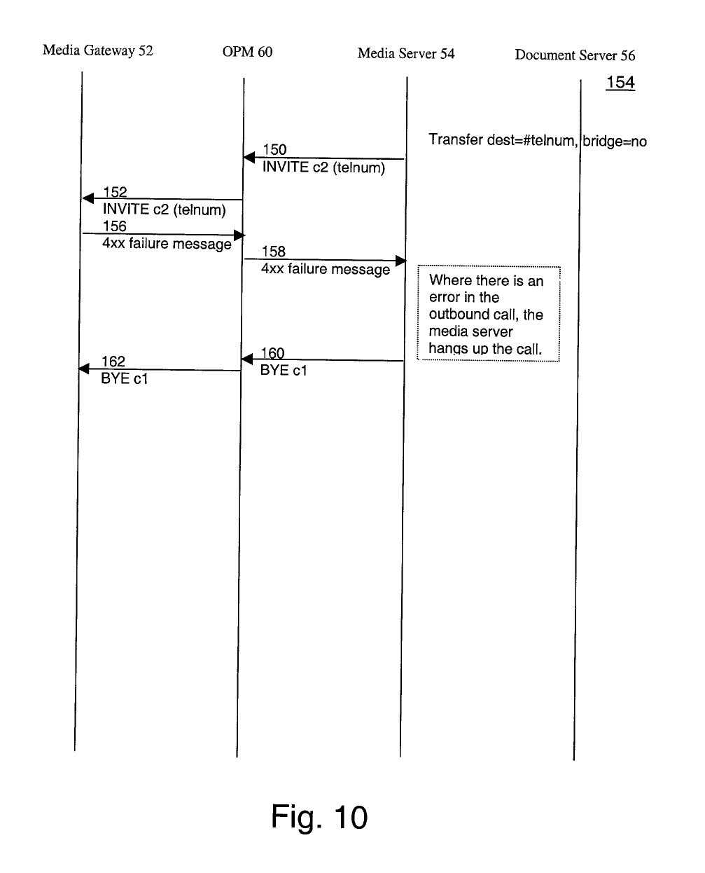

FIG. 10 illustrates a call flow 154, which shows an example of a failure during a call transfer. Similar to the scenario discussed above, the INVITE message 150 from the media server 54 includes the telephone number to which the call is to be transferred. This message is passed on to the media gateway (message 152), however, this time the media gateway responds with a failure message 156. The failure message 156 is an indication that the outbound call to the transfer destination telephone number could not be completed. The message is relayed by the OPM 60 to the media server 54 (message 158) and, because the bridge transfer flag was set to indicate no bridging, the media server drops the call (in accordance with current industry mandated requirements) and sends a BYE message 160 indicating this action to the OPM 60. The message is passed up to the media gateway (message 162) to allow the media gateway to release the call and free the associated resources. If appropriate under new or optional industry guidelines, the call may be handled differently (i.e., not dropped) so as to provide for a better user experience.

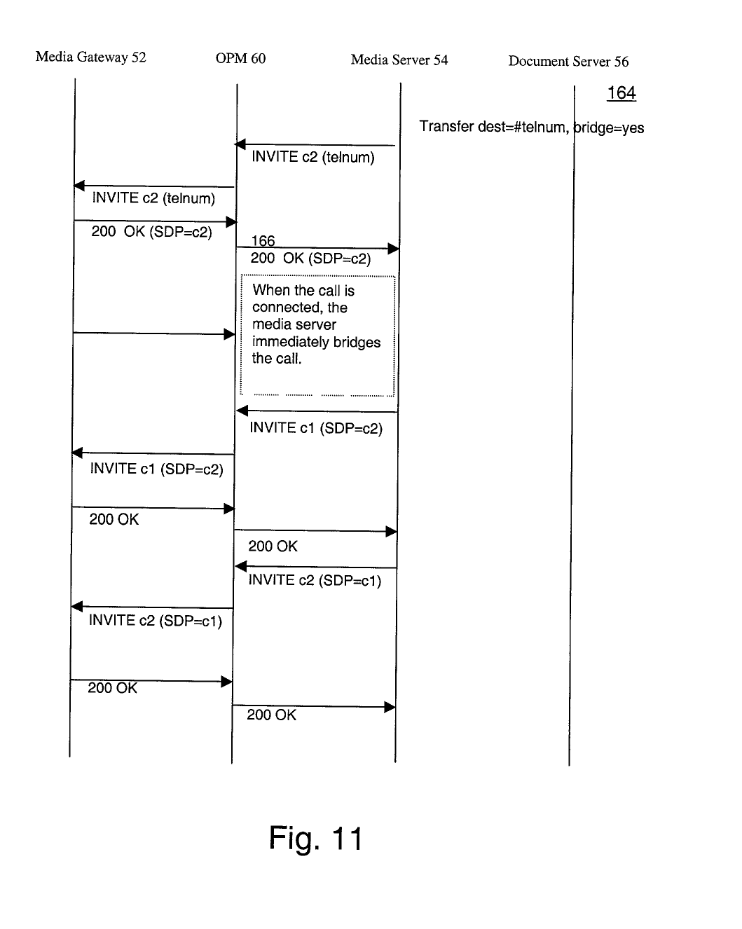

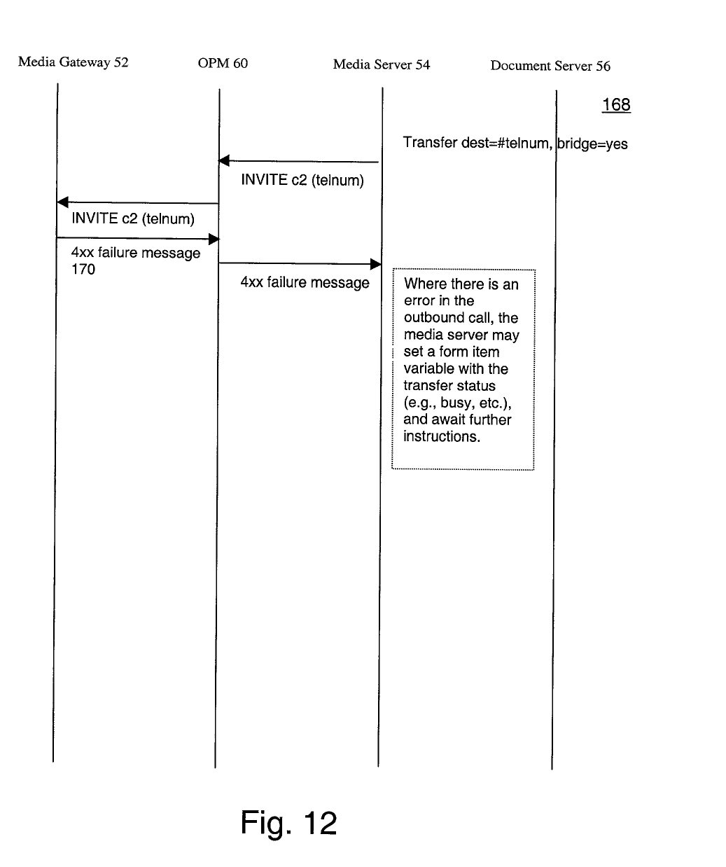

FIG. 11 illustrates a call flow 164, which is similar to the scenario discussed with reference to FIG. 10, however, this time a bridging flag is set to indicate bridging is to occur. As shown, once the call to the destination telephone number if connected (see OK message 166), the media server 54 immediately bridges the calls. In the case of a failure during such a call process, as illustrated in FIG. 12 with call flow 168, upon receipt of a failure message 170 the media server 54 may contact the document server to report a failure condition at which time the document server may pass instructions to attempt the transfer again or perform another action, such as reporting to the caller that the transfer request cannot be completed at the present time. This is in contrast to the situation discussed with reference to FIG. 10, where the call was simply dropped. Choosing between these failure options may be done by having an application set or not set the bridging flag when the transfer destination telephone number is reported to the media server 54 by the document server 56.

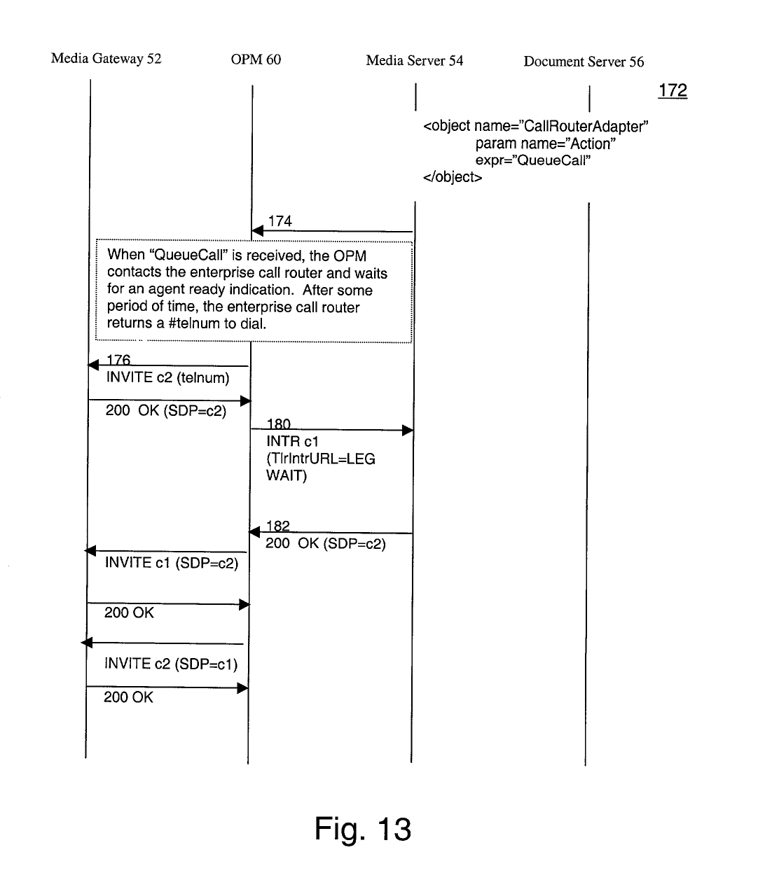

Call flow 172, shown in FIG. 13, represents an example of a call queuing operation. Such a situation may occur when an enterprise call router is to be used to provide transfer instructions for a call. An enterprise call router (rather than a document server) may be employed for such a purpose where transfers to different telephone numbers are decided dynamically, in response to current call conditions, for example.

Thus, in the call flow 172; the media server 54 receives a VXML object tag that has been specially created for use in such situations. The object is defined as follows:

<object name=“CallRouterAdapter”

classid=session.CallRouterAdapterURL
<param name=“Action”expr=“QueueCall”
<param name=“UserParams”

expr=“name1:value1,name2:value2, . . . ”>

</object>

This object tag thus invokes a URL (CallRouterAdapterURL), which is a pre-loaded session variable in the VXML execution context that actually translates to a URL at the OPM 60. The OPM 60 contacts the queue adapter 78 and passes on the application's request(e.g., to queue the call, etc.). When the media server 54 receives the object tag from the document server 56, it invokes the OPM 60 (message 174) using the URL set in the variable CallRouterAdapterURL. In response, the OPM 60 contacts the enterprise call router through the queue adapter 78 of the voice web manager 72. The OPM 60 then waits for the enterprise call router to return the destination telephone number for the transfer and, upon receipt thereof, passes the telephone number to the media gateway as part of an INVITE message 176, and the bridging process is completed as described above.

During this procedure, the media server 54 may be engaged in the playing of music or other messages to the caller. When the transfer call has been successfully placed by the media gateway 52 (as indicated by OK message 178), the OPM 60 issues an INTeRrupt message 180 to the media server 54, instructing the media server to stop whatever process it is executing and enter a LEG WAIT state. When the media server 54 has entered this waiting state, it returns an OK message 182 to the OPM 60. This process prepares the media server for the call bridging, which follows according to the fashion discussed above. OPM 60 initiates the bridging.

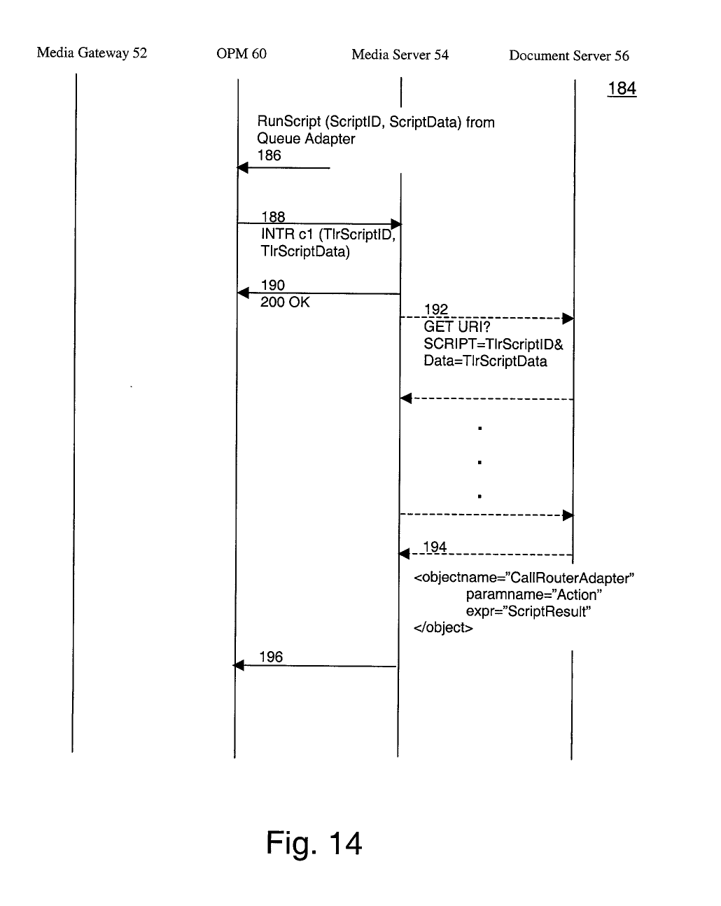

Turning now to FIG. 14, a call flow process 184, which illustrates the interaction between the media gateway 52, the OPM 60, the media server 54 and the document server 56 during a process wherein an IVR call application is executed according to instructions from an enterprise call controller, is shown. In this scenario an instruction (message 186) to run a script is received at the OPM 60 through the queue adapter 78 from an enterprise call router. A script ID identifies the script, and various data may also be passed (e.g., to set initial conditions for the script execution).

In response, the OPM 60 issues an interrupt instruction 188 to the media server 54, telling the media server to stop what ever it was doing and run the script identified by the script ID. An OK message 190 confirms receipt of the interrupt instruction.

To execute the script, the media server 54 performs a GET operation to a predefined URL from the document server 56, identifying the script ID and passing the script data as part of the message. Thereafter, the document server 56 and the media server 54 will communicate during execution of the script by the media server 54, until a VXML object tag reporting the script result is passed as part of a message 194. Such a tag may have the following format:

<object name=“CallRouterAdapter”

classid=session.CallRouterAdapterURL
<param name=“Action”expr=“ScriptResult”
<param name=“UserParams”

expr=“name1:value1,name2:value2, . . . ”>

</object>

In response to this message, the script results are reported up to the OPM 60 and onwards through the queue adapter to the enterprise call router. Examples of such results may include caller-entered data (e.g., a credit card number or a password, etc.) for a script that sought to collect such information. In this type of scenario, the enterprise call router acts like a call controller/supervisor, telling the media server which sets of instructions stored on the document server 56 to execute. This provides an alternative to using the starting URL feature discussed above, where a call center provider merely wishes to store various scripts at the document server and control calls (perhaps dynamically) using an existing enterprise call router.

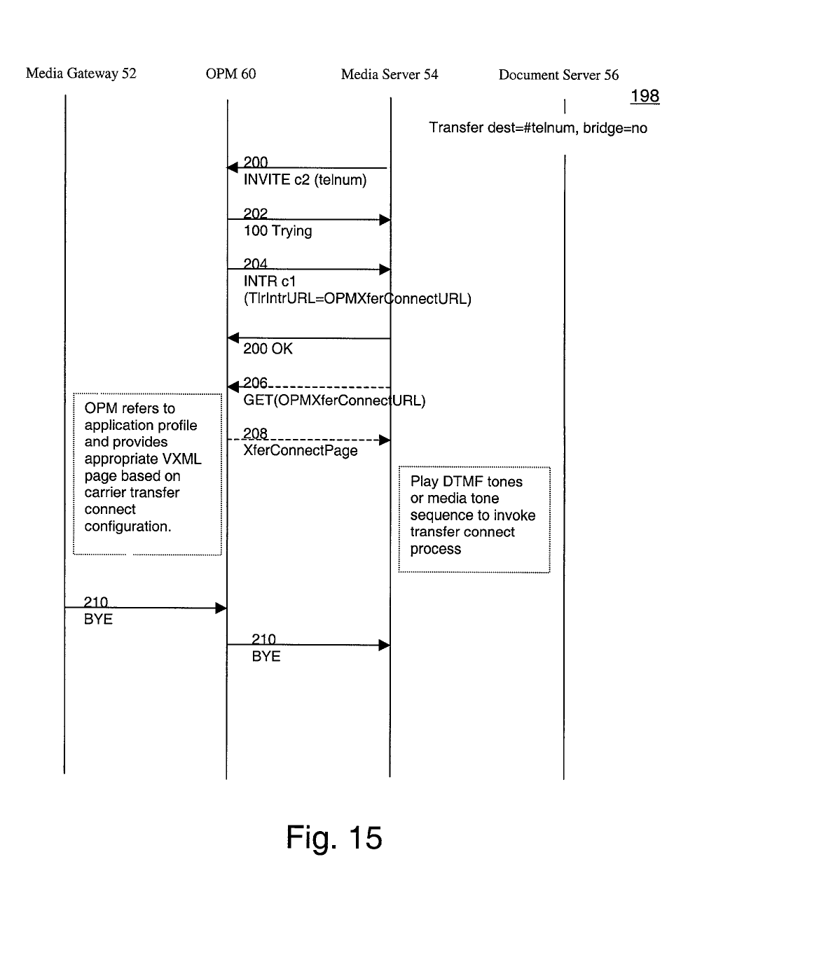

FIG. 15 illustrates a call flow 198 that provides an example of a carrier-based transfer connect call sequence. A transfer connect process is similar to a call bridging process, however, instead of using the media gateway 52 to connect an existing call with a newly placed call, the features of the PSTN are used to place the new call and perform the bridging. This is useful because it frees up resources at the media server and media gateway for new incoming calls.

The procedures for invoking a transfer connect process vary from carrier to carrier, but all rely on the use of a special sequence of DTMF tones. For example, AT&T uses a sequence beginning with *8, followed by the transfer destination telephone number and ending with the # symbol. Other carriers allow a user to designate a special sequence of tones to initiate a transfer connect process. Upon successfully placing the transfer call, the carrier's network passes a series of DTMF tones that instructs the call handling equipment (e.g., a media gateway) to release the current call to the transfer and the network completes the bridging.

The present invention can accommodate the use of any sequence of tones used to initiate a transfer connect process. As shown in the illustration, the process begins when the media server 54 receives an instruction from the document server to transfer the call and the destination number to be used. The invitation message 200 along with the destination telephone number is passed from the media server 54 to the OPM 60 as before, but this time instead of passing the INVITE on to the media gateway 52, the OPM 60 returns a TRYING message 202 to the media server 54.

In response to the TRYING message 202, the media server may play out music or other information to the caller, until it is interrupted (message 204) by the OPM 60. The interrupt message 204 includes a URL for the media server 54 to contact to initiate a transfer connect procedure. Rather than performing one of the bridging actions discussed above, this time the OPM 60 has consulted the application profile in directory 82 and found that the transfer process requires the use of in-band tones associated with a particular carrier. That is, the transfer connect tone sequence to be used for call transfers is specified in the application profile and the URL passed to the media server 54 as part of the interrupt message 204 refers to a page at the OPM 60 (i.e., the reliability handler 68 at which the media server 54 may download those instructions.

Therefore, the media server 54 performs a GET operation 206 to retrieve the designated page and that transfer connect page is passed back to the media server 54 (message 208). The page will include instructions for the media server 54 to play out the correct DTMF tone sequence to initiate the transfer connect process and upon completion of the transfer by the PSTN, the call is released through a series of BYE messages passed down by the media gateway 52. Note, the BYE messages originate at the media gateway 52 because it is the first network component notified by the PSTN that the call has been released to the transfer process.

Thus, an open portal interface manager (OPM), which in one embodiment may be implemented as computer software that provides open-protocols based application programming interfaces (APIs) to media gateways and media servers incorporating VXML engines has been described. Although discussed with reference to various examples and preferred embodiments, the present invention should only be measured in terms of the claims that follow.

[image]

[image]

What is claimed is:

1. A communications network comprising:
a media server;
a media gateway; and
a call controller configured to provide reliability handling for events experienced during a call session between the media server and the media gateway.

2. The communications network of claim 1 wherein the reliability handling includes the provisioning of voice extensible markup language (VXML) instructions to the media server to retrieve applications from one or more document servers.

3. The communications network of claim 2 wherein the VXML instructions include uniform resource locators (URLs) identifying the location of the applications.

4. The communications network of claim 2 wherein the media server comprises a VXML engine.

5. The communications network of claim 4 wherein the media gateway is coupled to receive inbound calls from a telephone network.

6. The communications network of claim 4 wherein the call controller includes an interface adapted for communication with an enterprise call router.

7. The communications network of claim 1 wherein the exception handling includes one or more of call rejection or call transfer.

8. The communications network of claim 7 further comprising a VXML document server communicatively coupled to the media server.

9. The communications network of claim 8 wherein the VXML document server stores the VXML application to be executed by the media server.

10. The communications network of claim 7 wherein the exception handling is based on application profiles for automated communication applications to be executed by the media server.

11. A method, comprising:
recognizing an event in a call flow process for an automated communication session in which the media server interacts with a caller through a media gateway; and
invoking, in response thereto and at an application server communicatively coupled with the media server and the media gateway, one or more reliability handlers for coping with the event according to an application profile for the automated call session.

12. The method of claim 11 wherein the reliability handlers provide one or more of: uniform resource locators (URLs) at which applications to be executed by the media server are located, call rejection instructions, or call transfer destination telephone numbers.

13. The method of claim 12 wherein the URLs correspond to documents stored at the application server.

14. The method of claim 12 wherein the URLs correspond to documents stored at one or more document servers communicatively coupled to the media server.

15. The method of claim 11 wherein the reliability handlers respond to the event by transmitting instructions to the media server to retrieve backup documents for processing a call from one or more document servers.

16. The method of claim 15 wherein the backup documents comprise one or more voice extensible markup language (VXML) applications.

17. The method of claim 11 wherein the event comprises one of: a timeout during communication between the media server and a document server, a document server error, a communication error between the document server and the media server, a page error, a resource failure error, an XML timeout error, an unexpected response from the document server, a call transfer process initiated by the media server, a call queuing operation initiated by the media server, a script execution initiated by an enterprise call router communicatively coupled to the application server, or a carrier-based transfer connect process requested by the media server.

18. A method, comprising performing call control operations at an application server communicatively coupled as a session initiation protocol (SIP) proxy between a media gateway and a media server according to application profiles for one or more automated communication applications to be executed by the media server according to voice extensible markup language (VXML) instructions, the call control operations being performed in response to events that occur during execution of the automated communication applications, said events including failures of the automated communication applications.

19. The method of claim 18 wherein the events comprises one or more of: a timeout during communication between the media server and a document server, a document server error, a communication error between the document server and the media server, a page error, a resource failure error, an XML timeout error, an unexpected response from the document server, a call transfer process initiated by the media server, a call queuing operation initiated by the media server, a script execution initiated by an enterprise call router communicatively coupled to the application server, or a carrier-based transfer connect process requested by the media server.

20. The method of claim 19 wherein the application profiles are retrieved from a directory accessible by the application server at a time when a call session is established.
